(19) United States
(12) Patent Application Publication
(10) Pub. No.: US 2009/0017644 A1
(43) Pub. Date: Jan. 15, 2009

(54) Land grid array connector assembly with pick up cap

(75) Inventors: Chia-Wei Fan, Tu-Cheng (TW); Hao-Yun Ma, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/825,864

(22) Filed: Jul. 9, 2007

(51) Int. Cl. H01R 13/60

(52) U.S. Cl. 439/42

(57) ABSTRACT

A connector assembly comprises a connector (2) comprising an insulative housing (21) being adapted for receiving an electronic package therein with a number of passageways therethrough and comprising a base portion (22) and a number of projections (23) extending from corners of the base portion (22), a plurality of electrical contacts received in the passageways of the housing (21) and a pick up cap (3) engagingly abutting against inner walls of the projections (23) of the housing (21) for locating the pick up cap (3) on the housing (21).

### BACKGROUND OF THE INVENTION

1. Field of the Invention

The present invention relates to a connector assembly which comprises connector and a pick up cap, the pick up cap being mounted to the connector for providing a flat top surface to be engaged by a vacuum suction device, whereby the connector assembly can be moved onto a circuit substrate such as a printed circuit board (PCB) on which the connector is to be mounted.

2. Description of the Prior Art

On many production lines, electronic components such as electrical connectors are accurately positioned on circuit substrates such as printed circuit boards (PCBs) by means of vacuum suction devices. Generally, a typical connector has a multiplicity of holes in an even top portion thereof, thereby having not a smooth and integral top surface to be engaged by a vacuum suction device. A pick up cap then has to be attached on the top portion of the connector to provide a flat top surface. Such pick up caps are disclosed in U.S. Pat. Nos. 6,413,111, 6,478,588, 6,533,592, 6,547,609, 6,561,825 and 6,572,383.

Referring to FIG. 6, there is shown an isometric view of a conventional pick up cap 9 used in an electrical connector 2. The connector comprises an insulative housing, a number of terminals received in the housing, and the housing defines an opening and a pair of anchoring recess arranged two opposite of the opening in a lengthwise direction. The pick up cap 9 has a substantially rectangular body portion 91. The body portion 91 has a flat top surface 910 and a pair of opposite ends each defines a rectangular hole and a cantilever extending from a center position of the hole. The cantilever comprises a pair of elastic hooks for engaging with the anchoring recess each. In addition, the cap defines pairs of positioning projections on lateral sides adjacent to the holes extending downwardly. In addition, there is further a connector which comprises a housing with sidewalls therearound and a rectangular pick up cap for vacuuming the housing. The pick up cap comprises pairs of hooks disposed on opposite laterals thereof for engaging with the housing and a number of locating projections disposed on a surface towards the housing arranged in symmetry.

However, in abovementioned electrical connector assemblies, the pick up caps are always located on the housing via projections extending from the cap which makes the structure of the pick up cap more complicated and when the assembled on the housing, the cap is easy to destroy the terminals assembled in the housing in addition, in the second electrical connector, the dimension of the cap is usually greater than the housing which is not fit the tendency of micromation of the connector.

In view of the above, a new connector assembly that overcomes the above-mentioned disadvantages is desired.

### SUMMARY OF THE INVENTION

Accordingly, an object of the present invention is to provide a connector assembly which has a connector and a pick up cap mounted on the connector, wherein the pick up cap is configured to have a minimal risk to damage the connector when a vacuum suction device engages a flat top surface of the pick up cap.

To achieve the above-mentioned object, a connector assembly in accordance with a preferred embodiment comprises an connector and a pick up cap. The connector comprises an insulative housing, a plurality of electrical contacts received in the housing. The housing comprises a conductive area and sidewalls extending around the conductive area comprising a pair of first sidewalls and a pair of second sidewalls connecting with the first sidewalls, the first sidewalls each define a first anchoring recess on a center portion thereof for engaging with pick up cap and the second sidewalls each defines a second anchoring recess on a center portion thereof for engaging with the pick up cap. The conductive area defines a number of passageways for receiving the terminals therein and each opposite sidewalls define a pair of anchoring recess one a center portion thereof respectively. The pick up cap is configured as rectangular shape and comprises a planar portion for being vacuumed by the vacuum suction device and a pair of first engaging portion extending from the planar portion in a first direction to engage with the first anchoring recess and a pair of second engaging portion extending from the planar portion in a second direction vertical to the first direction to engage with the second anchoring recess of the pick up cap. Each first engaging portion defines extending portion for engaging with anchoring recess of the pick up cap. Relative to the conventional art, the connector assembly provides pairs of engaging portion on the pick up cap for engaging with the connector, which simplifies the structure of the connector assembly and decreases the dimension of the whole connector assembly.

Other objects, advantages and novel features of the invention will become more apparent from the following detailed description when taken in conjunction with the accompanying drawings.

### BRIEF DESCRIPTION OF THE DRAWINGS

FIG. 1 is an assembled view of a connector assembly in accordance with the preferred embodiment of the present invention;

FIG. 2 is an exploded, isometric view of a connector assembly shown in FIG. 1;

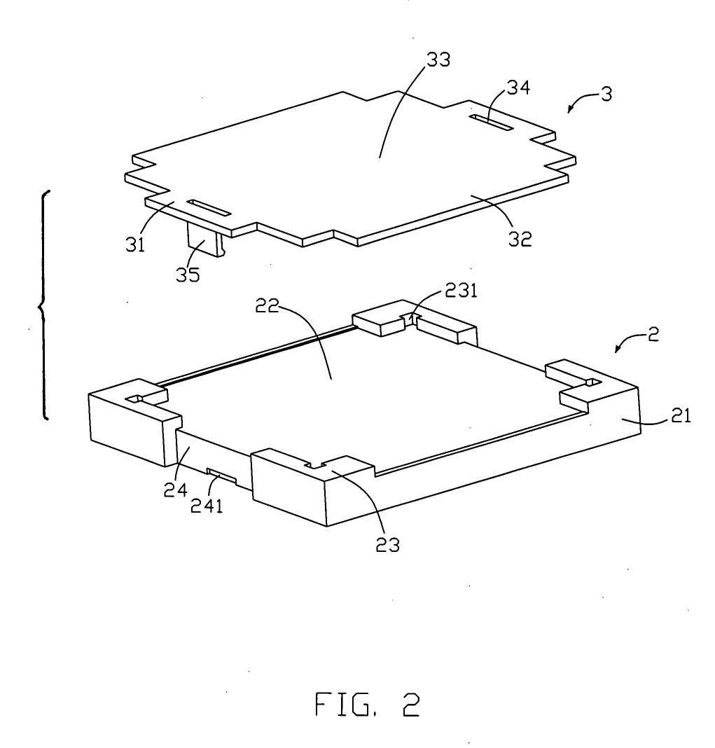

FIG. 6 is an isometric view of a conventional connector assembly;

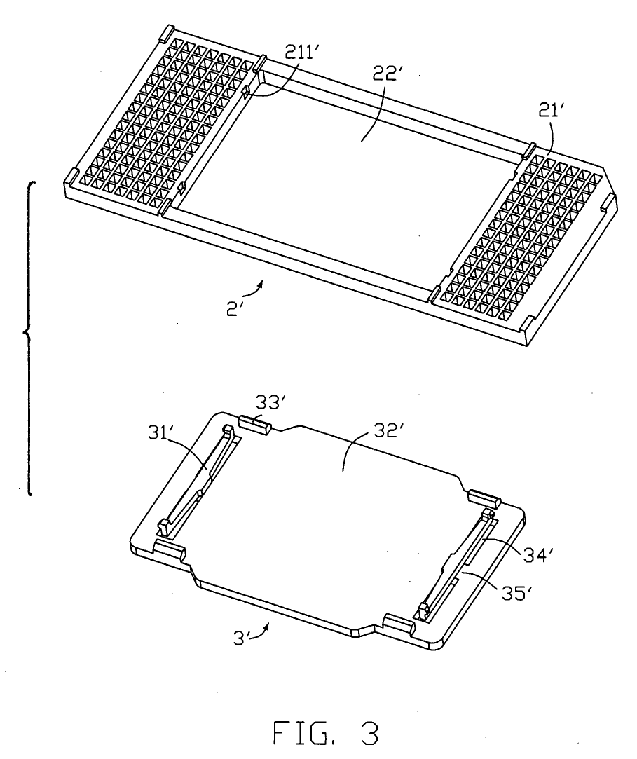

### DETAILED DESCRIPTION OF THE PREFERRED EMBODIMENT OF THE INVENTION

Reference will now be made to the drawings to describe the present invention in detail.

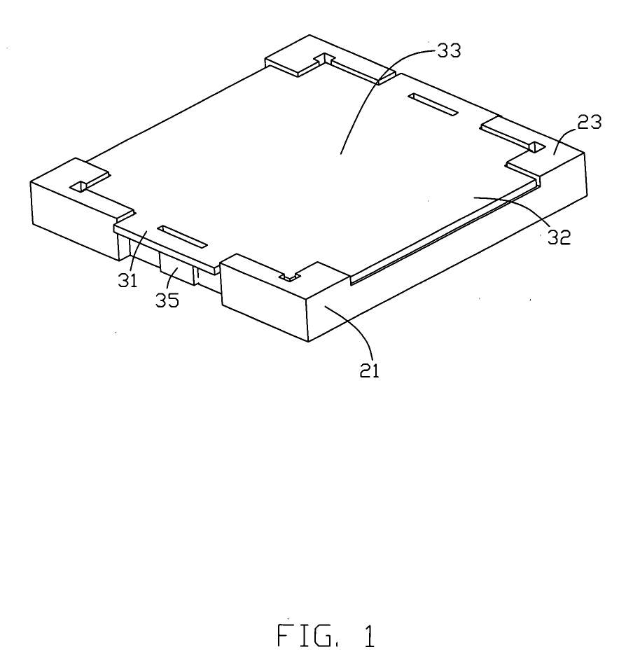

FIG. 1 is an exploded, isometric view of a connector assembly in accordance with the preferred embodiment of the present invention. The connector assembly comprises a connector 2 and a generally rectangular pick up cap 3. The pick up cap 3 is mounted onto the connector 2, for providing a flat top surface to be engaged by a vacuum suction device. The connector assembly can thereby be moved onto a circuit substrate, such as a printed circuit board (PCB) (not shown), on which the connector 2 is to be mounted.

The connector 2 comprises a generally rectangular insulative housing 21, a plurality of electrical contacts 22 received in the housing 21.

The housing 21 comprises a conductive area 22 and sidewalls extending around the conductive area comprising a pair of first sidewalls 220 and a pair of second sidewalls 221 connecting with the first sidewalls 220, the first sidewalls 220 each define a first anchoring recess 24 on a center portion thereof for engaging with pick up cap 3 and each recess defines an anchoring recess. The conductive area 21 defines a number of passageways for receiving the terminals therein. In addition, the housing 2 defines a number of L-shaped projections 23 on corners thereof extending towards the conductive area 21 and a number of recesses 231 each located in one corner sandwiched by the L-shaped projection 23.

The pick up cap 3 has a generally rectangular planar body 33. The planar body 33 comprises a flat top surface, and a pair of opposite first extending portions 31 and a pair of second opposite extending portions 32 extending horizontally from the sidewalls thereof. The first extending portions 31 each define a rectangular hole 34 adjacent to the planar body 33 and a hook 35 extending downwardly adjacent to the hole 33.

When the pick up cap 3 is mounted on the housing 2, the hook 35 of the pick up cap 3 is located on the anchoring recess 241 of the housing. The first extending portions 31 and the second extending portions 32 are abutting against sidewalls of the housing 2 and the corners of the pick up cap 3 are abutting against the inner sides of the projections 23. In the way, the pick up cap 3 is located on the housing 2 by its own structures.

Furthermore, although the present invention has been described with reference to particular embodiments, it is not to be construed as being limited thereto. Various alterations and modifications can be made to the embodiments without in any way departing from the scope or spirit of the present invention as defined in the appended claims.

1. A connector assembly, comprising:
a connector, comprising:
an insulative housing being adapted for receiving an electronic package therein with a number of passageways therethrough and comprising a base portion and a number of projections extending from corners of the base portion, and defining a recessed portion between every two adjacent projections;
a plurality of electrical contacts received in the passageways of the housing; and
a pick up cap engagingly abutting against inner walls of the projections of the housing for locating the pick up cap on the housing, and including an extending portion received in the recessed portion between two adjacent projections.

2. The connector assembly as claimed in claim 1, wherein said housing defines a conducting area and the projections are disposed extending from the corners of the housing towards the conducting area.

3. The connector assembly as claimed in claim 1, wherein said pick up cap is configured as rectangular shape and comprises a planar portion in center portion, and said extending portion as a first extending portion extending from the planar portion in a first direction, and a second extending portion extending from the planar portion in a second direction vertical the first direction.

4. The connector assembly as claimed in claim 1, wherein the pick up cap defines a hole between the first extending portion and planar portion and an anchoring portion extending adjacent to the hole.

5. (canceled)

6. The connector assembly as claimed in claim 1, wherein the projections are defined as L-shaped structure with a recess disposed in corners thereof.

7. (canceled)

8. A connector assembly comprising:
an insulative housing including a plurality of side walls having corresponding recessed portions thereof and commonly defining a receiving cavity therebetween configured and dimensioned to receive a corresponding CUP therein under condition that said interior surfaces are datum planes during assembling the CPU into the receiving cavity; and
a pick up cap defining a sucking plate with a plurality of engagement sides in compliance with the recessed portions of the side walls.

9. The connector assembly as claimed in claim 8, wherein the sucking plate is embedded in the receiving cavity.

10. The connector assembly as claimed in claim 8, wherein said pick up cap further includes two locking hook locked to the housing and within a contour of said housing.

11. The connector assembly as claimed in claim 8, wherein said pick up cap is configured substantially as a rectangular shape having the same dimension as the insulative housing.
